(19) United States
(12) Patent Application Publication
(10) Pub. No.: US 2023/0103442 A1
(43) Pub. Date: Apr. 6, 2023

(54) SYSTEM AND METHOD FOR SMART REMINDERS

(71) Applicant: Avaya Management L.P., Durham, NC (US)

(72) Inventors: Sandesh Chopdekar, Pune (IN); Pushkar Deole, Pune (IN); Navin Daga, Silapathar (IN)

(21) Appl. No.: 17/492,027

(22) Filed: Oct. 1, 2021

(51) Int. Cl. G06Q 10/10; H04L 12/58; G06F 9/54

(52) U.S. Cl. CPC G06Q 10/1095; H04L 51/043; G06F 9/542

(57) ABSTRACT

Static/Fixed-time meeting notifications may not be adequate and are not useful if the user is not online when the static/fixed-time reminder is sent. Systems, methods, and software to provide intelligent reminders. In one embodiment, presence data associated with a user is collected and stored. A calendar of the user is accessed to determine if any meetings have a start time occurring within a predetermined timeframe, wherein the predetermined timeframe is determined based on the presence data associated with the user. For each identified meeting that occurs within the predetermined time frame, determining a notification time based on the presence data associated with the user and presenting a notification at the determined notification time.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for smart notifications of future events. And more particularly providing dynamic meeting alerts based on a user's online presence data and past meeting attendance record.

### BACKGROUND

Online meetings, conferences, classes, and webinars continue to gain popularity, especially with a trend towards working from home. More and more sectors and industries, that previously required onsite attendance are adapting to having a remote workforce. Additionally, global organizations may have locations around the world with workers working in different time zones. As a result, more people frequently use online meetings and conferences as a mode to collaborate.

Traditionally, employees had a fixed schedule, for example, 8:00 am-5:00 pm with an hour lunch break. While the lunch hour may vary slightly from employee to employee, it was generally between 11:00 am-1:00 pm. However, with more and more employees working from home, these traditional work schedules may no longer apply.

A calendar application may provide static reminders for meetings, such as a fifteen-minute prompt before a scheduled meeting. For an attendee to notified of the meeting using a static reminder, the attendee needs to be online (e.g., logged into the device/application providing the notification) when the notification is sent (e.g., fifteen minutes prior to the meeting start time). While static/fixed-time reminders may be sufficient in some circumstances, this may not be universally true. For example, if a meeting is scheduled to start outside of an attendee's normal working hours (e.g., attendee is in different time zone), they may not be online to receive the notification. As a result, static reminders may be triggered when the user is offline and result in the user being late, unprepared, or missing the meeting entirely.

### SUMMARY

Calendar systems are often relied upon to provide meeting reminders at a specified time before the meeting. However, these reminders are fixed/static and do not take into account the attendee's work schedule, location/time zone, physical situation, past habits, time to connect to a network, launched applications, or other considerations. Similarly, fix-time reminders do not consider the relative status of the attendee (e.g., required, optional, etc.). Fixed-time reminders may come when the user is offline, such as outside their normal working hours, and therefore, the user would not receive the static reminder and may miss the meeting as a result.

Although work schedules may vary slightly in traditional in-person settings, the times are generally concentrated to specific core hours. Working From Home (WFH)/remote working provides employees with greater flexibility with their work schedules. Some employees may work better in the evenings, while other employees may prefer working in the early morning. Additionally, while WFH an employee may take breaks to handle other personal tasks (e.g., household chores, picking up kids from school, etc.). With the proliferation of employees WFH/remotely traditional work schedules are changing. In addition, with globalization employees may be working with colleagues around the world. Due to these changes, static/fixed-time reminders for meetings may not be as useful, as an attendee may miss it, which can lead to missed meetings. Therefore, it is important to present employees with intelligent reminders of their scheduled meetings when the employee is online and able to receive the reminders and provide dynamic alerts for meeting accordingly.

Intelligent/dynamic reminders leverage an employee's presence information, and past meeting data to determine when to send meeting reminders to an employee. In some embodiments, the system and method disclosed herein utilize various components, including: a calendar application, meeting/collaboration server (e.g., Avaya Spaces), a presence server (e.g., messenger application), etc.

The calendar application provides meeting alerts/notifications to the user. Meetings are scheduled in the calendar application. In some cases, the client calendar application is part of mail client like Outlook.

The meeting/collaboration server can be used to store past meeting data. For example, meetings that the user attended/missed and information about the associated meetings. A user may have missed other meetings that occurred at the same scheduled time as a current meeting request.

The presence server (e.g., Instant Messenger, Skype, Slack, etc.) includes a state for the user (e.g., logged on, active, busy, away, logged off, etc.). The presence server has the details of when an employee logs in, logs out, is active/away. This data can be used to determine when the user is normally online. If a scheduled meeting occurs outside of when a user is normally online, the reminder associated with the scheduled meeting may be adjusted to a time when the user is online.

The system according to the embodiments disclosed herein may include: an Active Time Determination Module (ATDM) and a Smart Alert Module (SAM). The ATDM determines the active hours of a user, and times the user normally misses meetings. To determine the active hours of a user, ATDM will average out the presence data it receives for the user (e.g., from the Presence Server). To determine times the user normally misses meetings an Artificial Intelligence (AI)/Machine Learning (ML) model may be used.

These and other needs are addressed by the various embodiments and configurations of the present invention. The present invention can provide a number of advantages depending on the particular configuration. These and other advantages will be apparent from the disclosure of the invention(s) contained herein.

In one embodiment, systems and methods are provided to automatically determine when a meeting reminder should be provided. A reminder is only effective if received by the attendee(s) in time to attend the scheduled meeting, therefore, reminders should be sent when the user is online and will be able to receive the reminder. Additionally, various indicators/alerts may be provided for meetings that occur outside the employee's normal working hours. For example, when an attendee accepts a meeting, a visual and/or audio alert/indicator may be provided as to the time of the meeting (e.g., meeting time is outside the normal working hours of the employee). For example, a pop-up may require additional confirmation before the user's response is sent. The user may also indicate another device on which to receive reminders (e.g., send SMS message to user's mobile phone).

Consider a meeting with a modest number of participants, such as ten, each receiving the prior-art fixed time reminder (e.g., fifteen minutes in advance of the meeting). For many participants, joining a meeting right at the time of the meeting (e.g., within less than one minute of the scheduled start time), discounting the other factors which play a role or even a significant role, in being able to join and/or participant in the meeting. For example, remote meetings may require logging in and establishing an internet connection, VPN setup, mobile network connectivity, launching a particular conferencing application, etc. As a result, meetings rarely start at the designated start late and participants often miss the initial part of the meetings. The problem increases exponentially as the number of participants increase. Static meeting reminders are easy to implement—but they fail to consider factors that may impact an attendee's ability to receive the reminder in order to attend the meeting on time.

Such factors may be if the attendees are located in different time zones, attendees work schedules, etc. However, default reminders do not take into consideration whether the attendee will be online to receive the reminder. As a result, a default fifteen-minute reminder requires manual modification, assuming the participant remembers to make such a modification, or risk being late or missing the meeting completely.

In one embodiment, an artificial intelligence (AI), neural network, and/or other machine learning (ML) is provided to enable a system to dynamically determine the timing and type of reminders necessary for a person to attend a meeting at the desired time. Over time the system learns which factors are more important and less important to further refine the timing of reminders. The specific factors utilized may be machine-discovered/determined and/or seeded, such as by known factors. The factors considered include, but are not limited to, the following: attendee's time zone; attendee's presence data/routine/work schedule; past meeting history, etc. In another embodiment, the AI/ML system learns from the user and/or other users.

The examples herein refer to a user which may be participant and/or a presenter of a virtual meeting, an in-person meeting, or a combination thereof. If the meeting is determined to occur within a predetermined time range (e.g., when the user is offline), the system will provide the user with a smart reminder when the user is still online (e.g., before the user logs off). For example, before a user logs off, the system may determine if any meetings are scheduled between when the user logs off and the next time the user normally logs on, if there are any meeting scheduled, the user will be notified of any scheduled meetings before they log off.

A cloud based smart meeting reminder can be integrated with all the devices used by the user and at all places. It will also be useful for in-office meetings for the list of factors considered.

In one embodiment, a system is disclosed, comprising: a network interface to a network; a data storage; and a processor having machine-readable instructions maintained in a non-transitory memory that when read by the processor cause the processor to perform: collect presence data associated with a user and store the presence data to the data storage; access a calendar of the user to determine if any meetings have a start time occurring within a predetermined timeframe, wherein the predetermined timeframe is determined based on the presence data associated with the user; for each identified meeting that occurs within the predetermined time frame, determine a notification time based on the presence data associated with the use; and for each identified meeting that occurs within the predetermined time frame, cause a user device to present a first notification at the determined notification time.

In another embodiment, a method is disclosed, comprising: collecting presence data associated with a user and storing the presence data to a data storage; accessing a calendar of the user to determine if any meetings have a start time occurring within a predetermined timeframe, wherein the predetermined timeframe is determined based on the presence data associated with the user; for each identified meeting that occurs within the predetermined time frame, determining a notification time based on the presence data associated with the use; and for each identified meeting that occurs within the predetermined time frame, causing a user device to present a first notification at the determined notification time.

In one embodiment, a non-transitory, computer-readable medium is disclosed, comprising: a set of instructions stored therein which, when executed by a processor, causes the processor to: collect presence data associated with a user and store the presence data to a data storage; access a calendar of the user to determine if any meetings have a start time occurring within a predetermined timeframe, wherein the predetermined timeframe is determined based on the presence data associated with the user; for each identified meeting that occurs within the predetermined time frame, determine a notification time based on the presence data associated with the use; and for each identified meeting that occurs within the predetermined time frame, cause a user device to present a first notification at the determined notification time.

Aspects of any one or more of the foregoing embodiments wherein the presence data indicates at least one of: when the user is detected as being online, normal work hours for the user, data regarding previously missed meetings, data regarding previously attended meetings, and scheduled break times for the user.

Aspects of any one or more of the foregoing embodiments wherein a respective start time for a respective meeting occurs outside of the user's normal working hours or at a time of a previously missed meeting.

Aspects of any one or more of the foregoing embodiments include accessing a set of past meetings maintained the data storage; and determining based of the set of past meetings an alteration of a time requirement associated with the notification.

Aspects of any one or more of the foregoing embodiments include associating one or more devices with the user and storing each association in the data storage; detecting the user is active on an associated device; and presenting a second notification on the associated device the user is detected as being active on.

Aspects of any one or more of the foregoing embodiments wherein the second notification is presented after the first notification.

Aspects of any one or more of the foregoing embodiments include adjusting the predetermined timeframe based on user input.

Aspects of any one or more of the foregoing embodiments include: receiving a meeting request; determining the received meeting request has an associated start time that occurs within the predetermined timeframe; and providing an additional alert to the user of the associated start time.

Aspects of any one or more of the foregoing embodiments include: receiving a meeting request, wherein the received meeting request has an associated start time that occurs within the predetermined timeframe; receiving user input indicating the user has accepted the meeting request; and providing an additional alert to the user of the associated start time.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects of the embodiments, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a first data structure in accordance with embodiments of the present disclosure;

FIG. 3 depicts a second data structure in accordance with embodiments of the present disclosure;

FIGS. 4A-B depict example alerts/indicators in accordance with embodiments of the present disclosure;

FIG. 5 depicts a second system in accordance with embodiments of the present disclosure;

FIG. 6 depicts a first process in accordance with embodiments of the present disclosure;

FIG. 7 depicts a second process in accordance with embodiments of the present disclosure;

FIG. 8 depicts a second system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

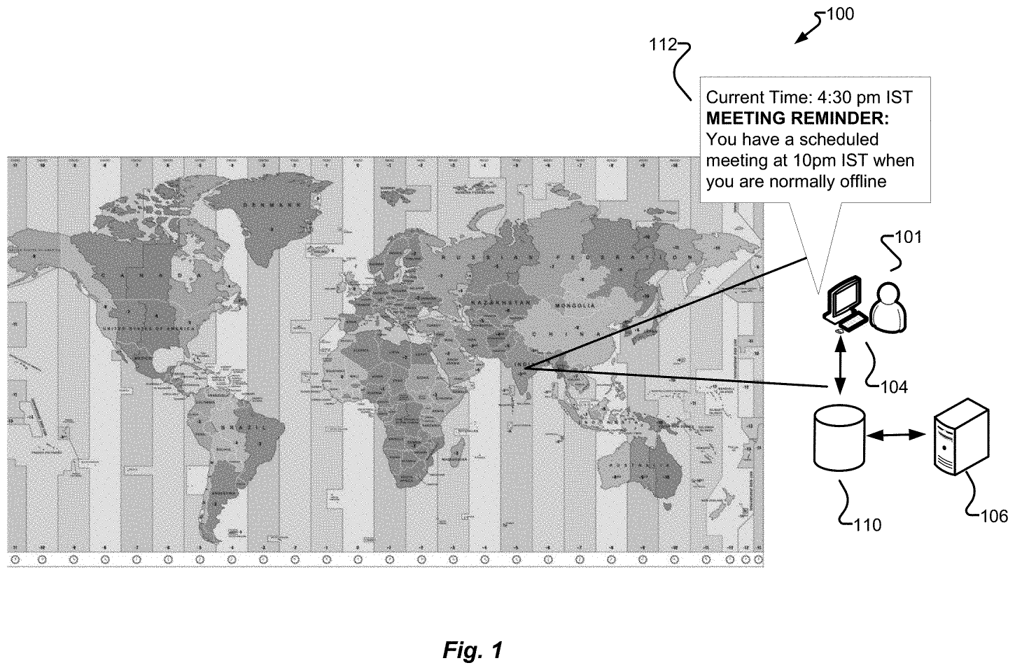

FIG. 1 depicts system 100 in accordance with embodiments of the present disclosure. In one embodiment, user 101 has associated therewith user device 104. A meeting maintained as a record in data storage 110 is accessed by at least one processor of a server 106 and communicated to user device 104, such as to provide smart notification 112 to notify user 101 of an upcoming meeting. The smart notification 112 is activated at a time that the user 101 is determined to be online.

It should be appreciated that the topology illustrated in system 100 may be modified without departing from the scope of the embodiments herein. For example, as illustrated, the user device 104, the server 106, and the data storage 110 are discrete components interconnected for communication of data therebetween. However, one or more components may be combined including, the user device 104 comprising the server 106 and the data storage 110. Components 104, 106, and 110 may communicate over a network (not shown) that may comprise any known data communication medium and associated hardware including, but not limited to, one or more of the internet, Wi-Fi, Bluetooth, etc.

In one embodiment, the data storage 110 comprises at least one database further comprising records for meetings to be attended by the user 101. The meetings are variously embodied and may comprise one or more of in-person or remote meetings, which may be in a traditional meeting format (e.g., some or all participants discussing particular topics), or other format, such as a class, seminar, lecture, presentation, etc., for which user 101 may be a passive participant (e.g., only receiving the meeting content), active participant (e.g., receiving and providing, at least in part, meeting content), a host (e.g., managing or moderator the meeting), or a combination thereof for throughout the meeting or having a changing role during the meeting. The data storage 110 may also store data (e.g., records) for past meetings.

Accordingly, the server 106 may comprise one or more processors executing machine learning, neural network, and/or other artificial intelligence in order to determine meeting attributes.

The user 101 may also provide preferences, such as may be maintained in the data storage 110, such as, normal working hours, alternate contact information, etc. For example, a user may configure a preference that indicates notifications/reminders for any meetings schedule during a specified timeframe should be delivered before the user logs off for the day. In another example, the system determines when the user normally logs on for the day, and determines if any meetings are scheduled after the user logs off and before the user is scheduled to log on again, and notifies the user of any identified meetings.

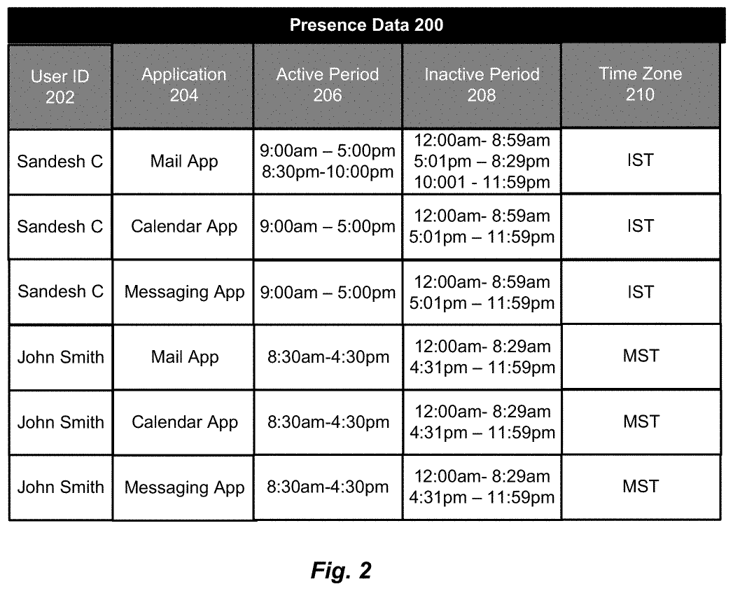

FIG. 2 depicts data structure 200 in accordance with embodiments of the present disclosure. In one embodiment, data structure 200 defines a database for presence data maintained in the data storage 110. The data structure 200 comprises a number of fields utilized by a processor of the server 106 to determine when a user is likely online, the sum of the presence data used to determine a time before a meeting in which the server 106 will cause the smart notification 112 to be triggered on the user device 104.

Data structure 200 may comprise User ID field 202, such as a name of the user associated with the record. Application field 204 identifies which application the data is obtained from (e.g., mail, calendar, messaging, etc.). Active Period field 206 indicates the time period(s) the user is active on the associated application. For example, a message application may store user status data (e.g., active, inactive, away, offline, etc.). Inactive Period field 208 indicates the time period(s) the user is inactive on the associated application. Additionally, or alternatively, the active/inactive period may apply to all applications/the system (e.g., when the user logs off from the system itself rather than closing/logging off from a specific application). For example, an email application may store data regarding when the mail application is open/active on the user device. Time Zone field 210 identifies the local time zone for the user (e.g., IST, MST).

As a result, the server 106 may iterate through a database of records having the data structure 200 and determine presence data for each user indicated by User ID field 202.

For example, active period 206 of the user 101 is compared to the time of a scheduled meeting to determine if the user will be online at the time of the scheduled meeting and/or when a static/fixed-time reminder (e.g., 15 minutes) is sent. If it is determined the user will not be online at the time of the scheduled meeting and/or a fixed-time before said meeting, a new notification time is determined (e.g., during the user's normal working hours, before the user logs off, etc.).

Additionally, the presence data gathered as described above, may then be used to train one or more Machine Learning (ML) models. To reduce false positives, filtering may be performed, such as to exclude redundant or otherwise unusable data. This data is used in subsequent determinations regarding dynamic/smart reminders. For example, an Artificial Intelligence (AI)/Machine Learning (ML) model training data set may be built by using a user's presence data such that the AI/ML model will keep evolving as more presence data is obtained for the user. Based on the AI/ML model, the system determines if a dynamic reminder/notification is required instead of static notifications/reminders (e.g., a meeting start time falls within a timeframe when the user is not online). Additionally, data for similar users may be used to train the AI/ML model. For example, users may be similar based on title, location, work schedules, team, etc.

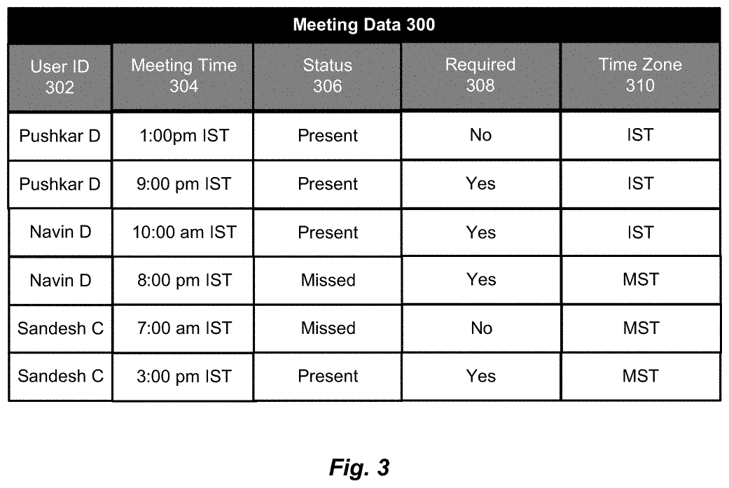

FIG. 3 depicts data structure 300 in accordance with embodiments of the present disclosure. In one embodiment, the data structure 300 may define records maintained in a database of the data storage 110. In one embodiment, the data structure 300 comprises past meeting data. More specifically, the field 302 identifies a user. The meeting time field 304 stores meeting time information. For example, the meeting times may be pulled from a calendar application. The status field 306 stores information about the status of the user for the associated meeting. For example, if the user was present or missed the meeting. The required field 308 indicates whether the user is a required or optional attendee. The time Zone field 310 identifies the local time zone for the user (e.g., IST, MST). In an embodiment, the server 106 determines the probability of a user missing a meeting based on meetings previously missed by the user.

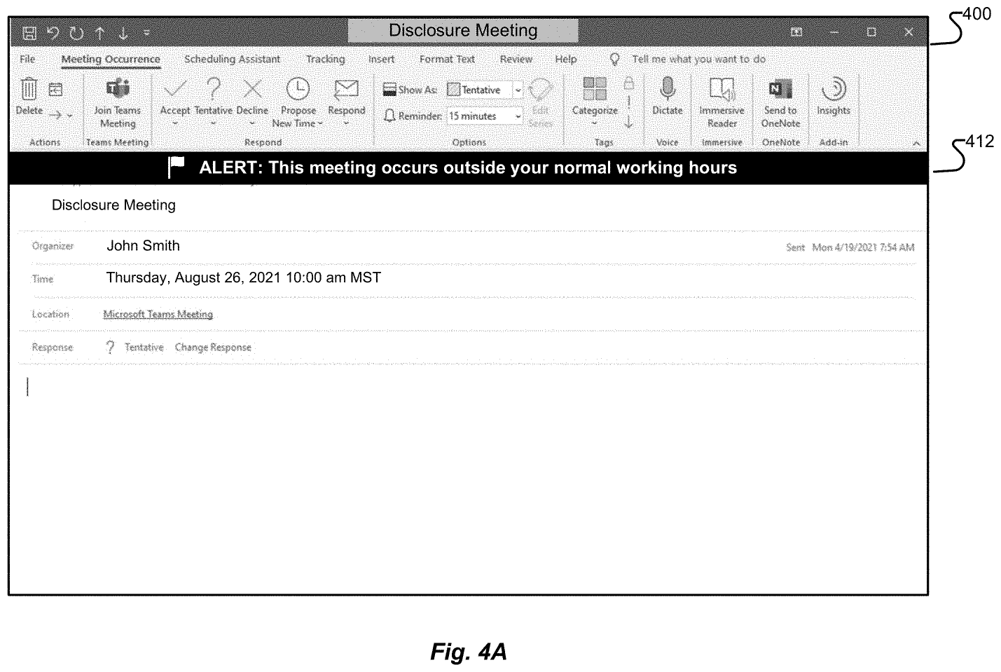

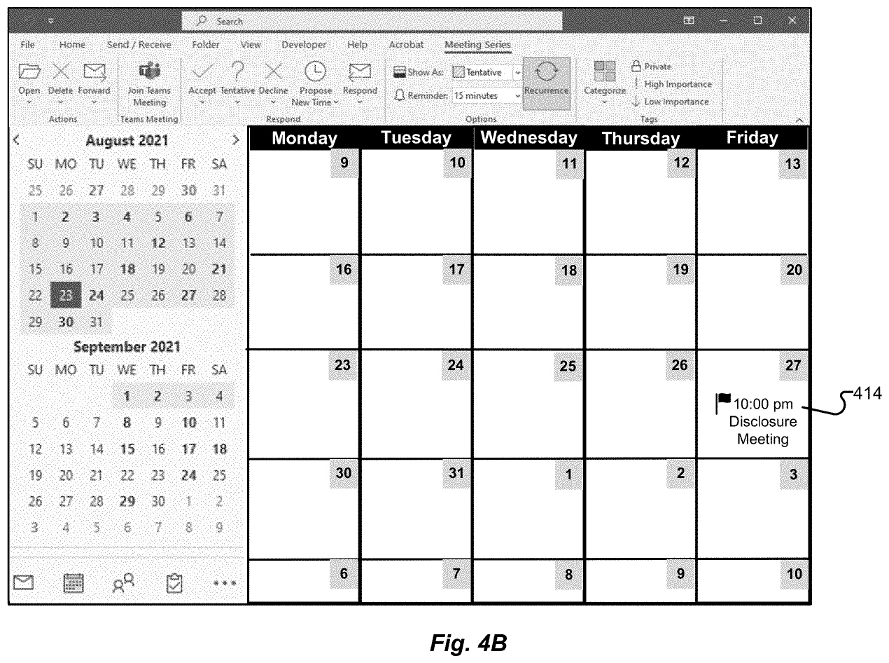

FIG. 4A depicts an example of an additional notification 412 in accordance with embodiments of the present disclosure. For example, a user (e.g., user 101) may receive a meeting invite 400. The meeting invite 400 includes the additional notification 412 as to the time of the meeting (e.g., “This meeting occurs outside your normal working hours.”). The additional notification 412 may be in a different color, or otherwise visually attract the user's attention.

FIG. 4B depicts an indicator 414 in accordance with embodiments of the present disclosure. For example, the user's calendar may visually indicate (e.g., designated icon) to the user (e.g., user 101) that the user may not be online at the time of the scheduled meeting.

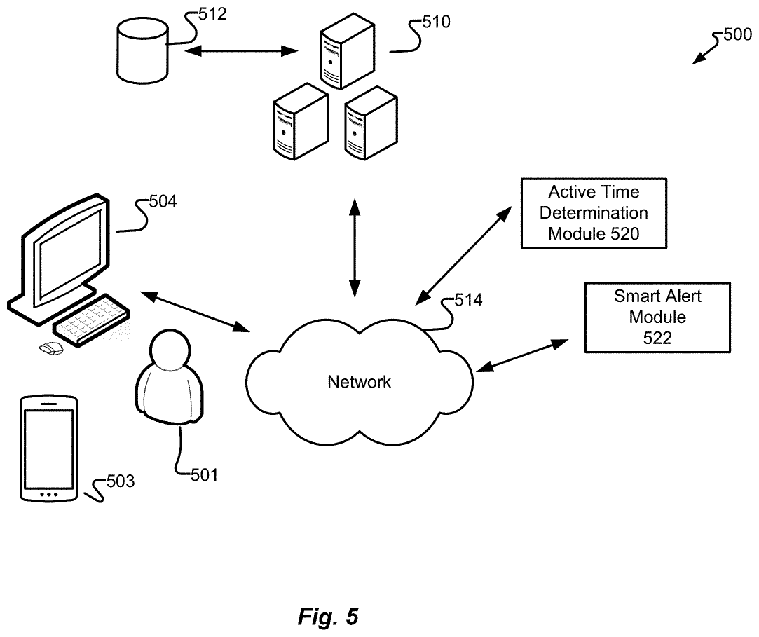

FIG. 5 depicts system 500 in accordance with embodiments of the present disclosure. In one embodiment, the system 100 includes a user 501, associated user devices 503 and 504, servers 510, a database 512, and a network 514. Although, one user 501 is shown, it is understood that there may be one or more users 101.

The user devices 503 and 503 may be embodied as, for example, a personal computer; a laptop; a smart phone. It should be appreciated by those of ordinary skill in the art that other user device may be utilized.

The servers 510 may have or utilize the database 512 as a non-transitory repository of data accessible to at least one microprocessor (or, more simply, “processor”) of the servers 510. The server 510 may be a stand-alone component or co-embodied with other components, such as to manage communications and/or other administrative and/or connectivity features. The server 510 may comprise or access, calendar/mail applications, presence server, collaboration server, telephony or other communication equipment (e.g., switches, hubs, routers, etc.) in order to facilitate establishing a communication session, etc. and receive user data from any of the user devices 503 and 504. In another embodiment, the servers 510 and/or the database 512 may be embodied as one device.

In some embodiments, an active time determination module (ATDM) 520 will fetch information from various sources like the presence server 510 and the collaboration server 510. From the presence server 510 it will fetch the information, regarding when an employee is active, away. offline, etc. Information regarding whether the employee is logged on from which device is also maintained, (e.g., whether it is mobile device, or a laptop, etc.). From the collaboration server 510 the ATDM 520 will gather information about an employee's meeting attendance records. Thus, the ATDM 520 will know, which meetings the employee has missed. Further the ATDM 520 will also consider, whether the employee was required/optional on the meeting, whether attendee RSVP′d as accepted, tentative, declined, etc., whether the meeting is a recurring meeting, the time the employee joined the meeting (e.g., on time, late, etc.), the reason the meeting was missed, etc. The system 500 via the servers 510, the ATDM 522, etc. may gather feedback on why a particular meeting was missed. Various options may be provided (e.g., forgot, time conflict, etc.).

From the user's presence data, the ATDM 520 may take an average and determine the possibility/probability of a user being available at a given point of time. The users IP address (subnet) may also be used to determine if the user is on-premise in the office or outside of the office. The ATDM 520 may average out the presence data information, and create a map of the users online hours for each weekday.

The averaged presence data information may be provided to a Smart Alert Module (SAM 522). For example, if an employee is online between 8 am to 5 pm local time daily, except on Fridays, when the employee is online from 7 am to 4 μm. The ATDM 520 will send the available time of the user to the SAM 522 as being online from 8 am to 5 pm, for Monday-Thursday and 7 am to 4 pm on Fridays.

A Machine Learning (ML) model will determine when an employee is active and when the employee is not active. Historical data may be used to train the model. Presence data associated with the employee, which will include presence information and past meeting data. The ML model will be trained to find time periods, if any, an employee is most likely to miss a meeting. Additionally, the ML model will generate a score (e.g., on a scale of 1-10), about the likelihood of a user attending a given meeting based on previously missed meetings and the user's presence data. The higher the score, the higher the likelihood of the user attending the meeting. The ATDM 520 may also provide this score to the SAM 522, so that the SAM 522 can provide meeting alerts in a smarter manner. The ATDM 520 may also determine the time period before a scheduled meeting, when the user is mostly active.

In some embodiments, the SAM 522 may reside on a calendar server 510. Using the ATDM 520, the SAM 522 will use inputs received from the ATDM 520 to determine when an employee is online/offline, in order to provide intelligent alerts. For example, if the SAM 522 determines a user is normally offline, at a scheduled meeting time. It may determine, when the user is last active before the meeting, and send a meeting reminder/alert before the user goes offline. For example, if there is a meeting scheduled to start at 7.30 μm, and the user normally goes offline at 5 pm, the SAM 522 may be configured to provide 2 alerts in such cases (e.g., a first one at 4.45 pm and a second one at 4.55 pm). Additionally, or alternatively, the user may configure another device (e.g., smart phone) to receive meeting reminders/alerts closer to the time of the scheduled meeting (e.g., a first one at 7:00 μm and a second one at 7:15 pm). It can also further be smart, about the alerts, based on whether the person is required/optional for a meeting. In some embodiments, a user can configure the time (e.g., in minutes) before they go offline, for alerts to be displayed. For example, provide alerts 10 minutes before the user usually goes offline.

In some embodiments, if a user is required for the meeting (e.g., hosting, presenting, etc.), and the score of attending meeting at the scheduled time is low (e.g., 4 or lower), the system may be configured to provide multiple alerts, before the user goes offline.

In another embodiment, there may be an option to show all alerts for meetings scheduled within a specified time period (e.g., the next 24 hours), meetings scheduled for the day at start of day.

In one example, a meeting is scheduled on Friday 2:00 μm, and the ATDM 520/SAM 522 determines that the employee is usually offline/away at the scheduled time. Additionally, data from the ATDM 520 indicates that the employee is online until 1:30 pm. If the configuration is to give alerts 10 minutes before the user goes offline/away, the SAM 522 will display the meeting alert at 1:20 pm, e.g., 10 minutes before the employee goes away/offline.

In another example, an employee has a meeting at 7:00 μm in the evening, and from the past meeting history, the ATDM 520/SAM 522 determines that the employee is online till 6:00 pm, away till 6:15 μm, and is offline thereafter. Therefore, at 5:55 pm, the SAM 522, will pop up a notification to the employee that there is a scheduled meeting at 7:00 pm today.

In another example, when a meeting invite is received and if the ATDM 520/SAM 522 determines that the employee has a higher probability of missing meetings at the scheduled time, and/or is not online at that time, the ATDM 520/SAM 522 will provide an alert to the user, which will convey to the user, that the meeting is scheduled at a time, when the user usually misses/does not attend meeting or is offline. Using this information, the user, may proactively request a new meeting time.

Additionally, or alternatively, the user 501 may configure alerts to be directed to another user device (e.g., user device 503) during a specified timeframe. In some embodiments, the system 500 may detect the user's presence on another device (e.g., the user device 503) and alert the user on that device.

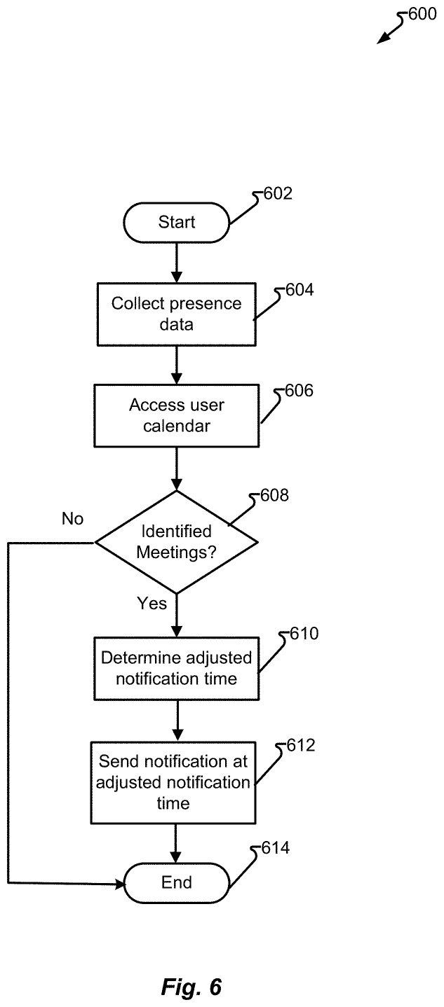

FIG. 6 depicts process 600 in accordance with embodiments of the present disclosure. Process 600 may be embodied as machine-readable instructions maintained in a non-transitory memory that, when read by a processor such as a processor of user device(s) 104, 503, 504 or server(s) 106, 510, ATDM 520, SAM 522 to cause the processor to execute the steps of process 600.

In one embodiment, process 600 begins at step 602 and ends at step 614. In step 604. presence data associated with a user is collected and stored (e.g., the database 200). In step 606 the user's calendar is accessed to determine if any meetings have a start time occurring within a predetermined timeframe (step 608), wherein the predetermined timeframe is determined based on the presence data associated with the user. If no meeting are identified (No), then the process 600 ends. If one or more meetings are identified (Yes), then in step 610, for each identified meeting that occurs within the predetermined time frame, an adjusted notification time is determined based on the presence data associated with the user. In step 612, the notification is sent at the adjusted notification time. The process 600 ends in step 614.

The steps may be performed continuously, while other steps of process 600 are executed, until the process is concluded.

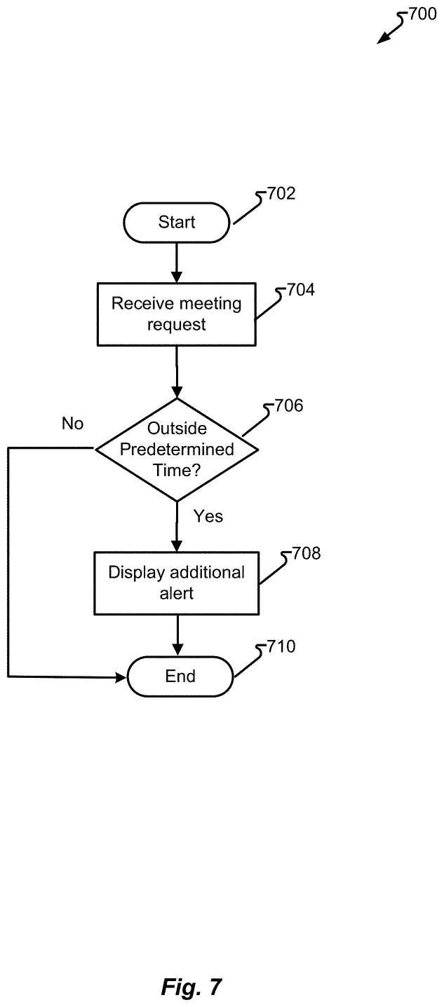

FIG. 7 depicts process 700 in accordance with embodiments of the present disclosure. Process 700 may be embodied as machine-readable instructions maintained in a non-transitory memory that, when read by a processor such as a processor of user device(s) 104, 503, 504 or server(s) 106, 510, ATDM 520, SAM 522 to cause the processor to execute the steps of process 700.

In one embodiment, process 700 begins at step 702 and ends at step 710. In step 704 a meeting request/invite is received. In step 706, the system determines if the scheduled meeting time associated with the meeting invite occurs outside a predetermined timeframe (e.g., outside the user's normal working hours), if the scheduled meeting time is not outside the predetermined timeframe (No), the process 700 ends. If the scheduled meeting time is outside the predetermined timeframe (Yes), in step 708 an additional alert (e.g., alert 412) is displayed. In step 710 process 700 ends.

The steps may be performed continuously, while other steps of process 700 are executed, until the process is concluded.

In another embodiment, the notifications may comprise a number of notifications based on time and/or priority. For example, a high-priority meeting may have an additional notification presented, such as at a time associated with high-priority meetings, and another notification triggered upon the normal time, that is, the summation of delay factors before the meeting. Additionally, or alternatively, the type of alert may be modified based on time and/or priority. For example, a passive reminder may be presented for normal-priority meetings that disappears if ignored when presented before the normal notification trigger. Then, at the normal notification trigger the notification is emphasized (e.g., requires acknowledgement, louder, comprises a spoken message, etc.). Low-priority meetings may have low-priority notifications that disappear even if not acknowledged, or only require acknowledgement after the normal notification time has passed.

A neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive.

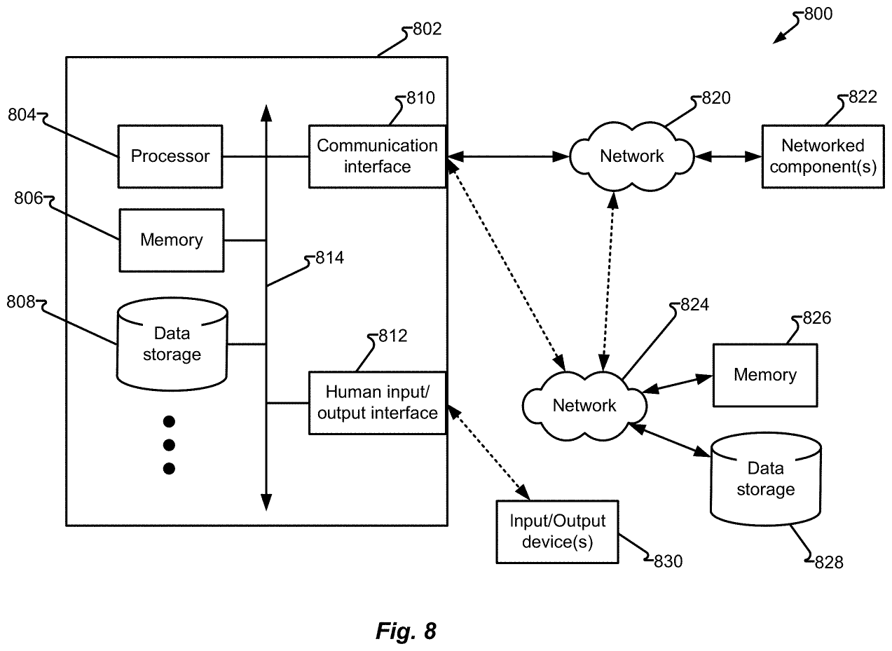

FIG. 8 depicts device 802 in system 800 in accordance with embodiments of the present disclosure. In one embodiment, user device 118 may be embodied, in whole or in part, as device 802 comprising various components and connections to other components and/or systems. The components are variously embodied and may comprise processor 804. The term “processor,” as used herein, refers exclusively to electronic hardware components comprising electrical circuitry with connections (e.g., pin-outs) to convey encoded electrical signals to and from the electrical circuitry. Processor 804 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 814, executes instructions, and outputs data, again such as via bus 814.

In other embodiments, processor 804 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 804 is a non-transitory computing device (e.g., electronic machine comprising circuitry and connections to communicate with other components and devices). Processor 804 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 804). Processor 804 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 804, device 802 may utilize memory 806 and/or data storage 808 for the storage of accessible data, such as instructions, values, etc. Communication interface 810 facilitates communication with components, such as processor 804 via bus 814 with components not accessible via bus 814. Communication interface 810 may be embodied as a network port, card, cable, or other configured hardware device. Additionally, or alternatively, human input/output interface 812 connects to one or more interface components to receive and/or present information (e.g., instructions, data, values, etc.) to and/or from a human and/or electronic device. Examples of input/output devices 830 that may be connected to input/output interface include, but are not limited to, keyboard, mouse, trackball, printers, displays, sensor, switch, relay, speaker, microphone, still and/or video camera, etc. In another embodiment, communication interface 810 may comprise, or be comprised by, human input/output interface 812. Communication interface 810 may be configured to communicate directly with a networked component or utilize one or more networks, such as network 820 and/or network 824.

Network 820 may be a wired network (e.g., Ethernet), wireless (e.g., Wi-Fi, Bluetooth, cellular, etc.) network, or combination thereof and enable device 802 to communicate with networked component(s) 822. In other embodiments, network 820 may be embodied, in whole or in part, as a telephony network (e.g., public switched telephone network (PSTN), private branch exchange (PBX), cellular telephony network, etc.)

Additionally, or alternatively, one or more other networks may be utilized. For example, network 824 may represent a second network, which may facilitate communication with components utilized by device 802. For example, network 824 may be an internal network to a business entity or other organization, whereby components are trusted (or at least more so) that networked components 822, which may be connected to network 820 comprising a public network (e.g., Internet) that may not be as trusted.

Components attached to network 824 may include memory 826, data storage 828, input/output device(s) 830, and/or other components that may be accessible to processor 804. For example, memory 826 and/or data storage 828 may supplement or supplant memory 806 and/or data storage 808 entirely or for a particular task or purpose. For example, memory 826 and/or data storage 828 may be an external data repository (e.g., server farm, array, “cloud,” etc.) and allow device 802, and/or other devices, to access data thereon. Similarly, input/output device(s) 830 may be accessed by processor 804 via human input/output interface 812 and/or via communication interface 810 either directly, via network 824, via network 820 alone (not shown), or via networks 824 and 820. Each of memory 806, data storage 808, memory 826, data storage 828 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 1130 may be a router, switch, port, or other communication component such that a particular output of processor 1104 enables (or disables) input/output device 1130, which may be associated with network 1120 and/or network 1124, to allow (or disallow) communications between two or more nodes on network 1120 and/or network 1124. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system, comprising:
a network interface to a network;
a data storage; and
a processor having machine-readable instructions maintained in a non-transitory memory that when read by the processor cause the processor to perform:
collect presence data associated with a user and store the presence data to the data storage;
associating one or more devices with the user and storing each association to the data storage;
access a calendar of the user to determine if any meetings have a start time occurring within a specified timeframe, wherein the specified timeframe is determined based on the presence data associated with the user;
for each identified meeting that occurs within the specified time frame, determine a notification time based on the presence data associated with the use;
for each identified meeting that occurs within the specified time frame, present a first notification at the determined notification time; and
in response to detecting the user is active on an associated device, presenting a second notification on the associated device the user is detected as being active on, wherein the second notification is presented after the first notification.

2. The system of claim 1, wherein the presence data indicates at least one of: when the user is detected as being online, normal work hours for the user, data regarding previously missed meetings, data regarding previously attended meetings, and scheduled break times for the user.

3. The system of claim 1, wherein a respective start time for a respective meeting occurs outside of the user's normal working hours or at a time of a previously missed meeting.

4. The system of claim 3, wherein the instructions cause the processor to:
access past meeting data maintained in the data storage; and
determine based on the past meeting data an alteration of a time requirement associated with the first notification.

5. (canceled)

6. (canceled)

7. The system of claim 1, wherein the instructions cause the processor to:
adjust the specified timeframe based on user input.

8. The system of claim 1, wherein the instructions cause the processor to:
receive a meeting request;
determine the received meeting request has an associated start time that occurs within the specified timeframe; and
provide an additional alert to the user of the associated start time.

9. The system of claim 1, wherein the instructions cause the processor to:
receive a meeting request, wherein the received meeting request has an associated start time that occurs within the specified timeframe;
receive user input indicating the user has accepted the meeting request; and
provide an additional alert to the user of the associated start time.

10. A method, comprising:
collecting presence data associated with a user and storing the presence data to a data storage;
associating one or more devices with the user and storing each association to the data storage;
accessing a calendar of the user to determine if any meetings have a start time occurring within a specified timeframe, wherein the specified timeframe is determined based on the presence data associated with the user;
for each identified meeting that occurs within the specified time frame, determining a notification time based on the presence data associated with the use;
for each identified meeting that occurs within the specified time frame, presenting a first notification at the determined notification time; and
in response to detecting the user is active on an associated device, presenting a second notification on the associated device the user is detected as being active on, wherein the second notification is presented after the first notification.

11. The method of claim 10, wherein the presence data indicates at least one of: when the user is detected as being online, normal work hours for the user, data regarding previously missed meetings, data regarding previously attended meetings, and scheduled break times for the user.

12. The method of claim 10, wherein a respective start time for a respective meeting occurs outside of the user's normal working hours or at a time of a previously missed meeting.

13. The method of claim 12, further comprising:
accessing past meeting data maintained in the data storage;
determining based on the past meeting data an alteration of a time requirement associated with the first notification.

14. (canceled)

15. (canceled)

16. The method of claim 10, further comprising:
adjust the specified timeframe based on user input.

17. The method of claim 10, further comprising:
receiving a meeting request;
determining the received meeting request has an associated start time that occurs within the specified timeframe; and
providing an additional alert to the user of the associated start time.

18. The method of claim 10, further comprising:
receiving a meeting request, wherein the received meeting request has an associated start time that occurs within the specified timeframe;
receiving user input indicating the user has accepted the meeting request; and
providing an additional alert to the user of the associated start time.

19. A non-transitory, computer-readable medium comprising a set of instructions stored therein which, when executed by a processor, causes the processor to:
collect presence data associated with a user and store the presence data to a data storage;
associating one or more devices with the user and storing each association to the data storage;
access a calendar of the user to determine if any meetings have a start time occurring within a specified timeframe, wherein the specified timeframe is determined based on the presence data associated with the user;
for each identified meeting that occurs within the specified time frame, determine a notification time based on the presence data associated with the use;
for each identified meeting that occurs within the specified time frame, cause a user device to present a notification at the determined notification time; and
in response to detecting the user is active on an associated device, presenting a second notification on the associated device the user is detected as being active on, wherein the second notification is presented after the first notification.

20. The non-transitory, computer-readable medium of claim 19, wherein the instructions cause the processor to:
receive a meeting request, wherein the received meeting request has an associated start time that occurs within the specified timeframe;
receive user input indicating the user has accepted the meeting request; and
provide an additional alert to the user of the associated start time.
